(19) United States
(12) Patent Application Publication
(10) Pub. No.: US 2003/0023949 A1
(43) Pub. Date: Jan. 30, 2003

(54) Storage administration

(75) Inventors: Joachim Hagmeier, Stuttgart (DE); Jutta Kreyss, Stuttgart (DE); Bassam T. Salem, Park City, UT (US)

Correspondence Address: Cynthia S. Byrd, International Business Machines, Intellectual Property Law, 11400 Burnet Rd., Austin, TX, 78758, US

(73) Assignee: INTERNATIONAL BUSINESS MACHINES CORPORATION, ARMONK, NY

(21) Appl. No.: 10/185,705

(22) Filed: Jun. 27, 2002

(30) Foreign Application Priority Data
Jul. 6, 2001 (DE) 01116478.7

(51) Int. Cl. G06F 9/44

(52) U.S. Cl. 717/101; 717/178

(57) ABSTRACT

The present invention relates generally to storage administration of computer systems and in particular to a method for managing storage resources of computer systems. A method is proposed in which so-called ‘first category’ program data is managed with a first Storage Management System (STMS) (14) in a first address space (25), and so-called ‘second category’ program data is managed with a second STMS (16) in a separate space (26). Each STMS can be provided by a separate heap or any other suited memory management means dependent of the actual business context, operating system, and hardware in regard. According to a further aspect different categories have different temporal nature: the first category data is associated with persistent data, whereas the second category data is associated with transient data, whereby the storage resources (25) used for transient data are re-initialized for each transaction. Said re-initialization comprises a deallocation of storage which is not explicitly deallocated by the programmer. Thus, storage efficiency and runtime safety is increased further even if the programmer missed to deallocate some program data which is really no more needed for the further run of a program.

1. BACKGROUND OF THE INVENTION

1.1 Field of the Invention

The present invention relates generally to storage administration of computer systems. In particular, it relates to a method for managing storage resources of computer systems.

1.2 Description and Disadvantages of Prior Art

Modern computer programs are often quite complex. During software development many requirements must be considered. First, find out and strictly keep track of the client's business intentions to be covered by the program under development, second, build-up a clear programming concept reflecting said business intention, and third, implement said concept such that the program performs as desired by the client, i.e., running stable and performant without occurring any problems interfering the business process supported by the program.

The software developers who are charged with the task to create such a program have a difficult work to do because they must satisfy all of the above-mentioned requirements. There are plenty of potential misleading development steps if the program development is not strictly and rigorously structured:

Prior art program development tools, however, like e.g., a Visual Basic development workbench do not reflect really this situation: They support only a portion of the requirements, mostly they support the implementation steps which follow after having established a fine structured logic programming concept.

They do not support, however, any facility to structure data or variables of the program under development according to and adapted to the business process in which those data or variables are used. Such a support, however, would be strongly desired because any data or variables may have important differences in their business nature, as well as in their programming nature. For example, some category of data is of absolute high business interest and is thus strongly desired to be kept safe and maybe thus recommended to be stored redundantly. Or, another data is a kind of key data for other business processes to follow and must thus be stored redundantly on more than one physical location, as well, for example in a file system as well as in a database in order to make sure that other programs have the desired access to said data.

Or, regarding runtime aspects and storage administration during loops or transactions, respectively, some category of data or variables has a transient nature and some has a more persistent nature, some might be a combination of the two. In programming languages without a so-called garbage collector the main memory is a storage resource which has to be administrated autonomously by the programmer, a fact behind which a lot of risks and potential runtime problems is hidden: When those loops are run a large number of times then the available main memory or other storage resources as well might be successively reduced. Said risk is further increased with increasing complexity of a program because the program developer is let alone and remains unsupported by his development tool when he has to take decisions how to manage selected ones of data or variables in regard of the above mentioned different categories of data, or variables, respectively.

The above mentioned criteria as e.g., important/less important, “predetermined storage location desired” or “not desired”, transient/persistent—established for creating different categories of program data are of course not complete. Further criteria may be found according to the current business situation and according to the particular requirements for the program under development.

### 1.3 Objectives of the Invention

It is thus an objective of the present invention to provide a method for managing storage resources by which a programmer is better supported in regard of questions related to the business environment in which the application program is intended to be used.

### 2. SUMMARY AND ADVANTAGES OF THE INVENTION

Said objective of the invention is achieved by the features stated in enclosed independent claims. Further advantageous arrangements and embodiments of the invention are set forth in the respective subclaims.

According to its primary aspect a method for managing storage resources required for program data is proposed in which so-called first category program data is managed with a first Storage Management System (STMS), and so-called second category program data is managed with a second STMS. Instead of two, three or more STMSs may be associated to a respective plurality of categories, as well. Each STMS can be provided by a separate heap or any other suited memory management means dependent of the actual business context, operating system, and hardware in regard.

The separation into two or more STMSs instead of a single STMS, as done in prior art allows for a storage management which is separately associable with somehow fundamentally different categories of data, each. The term ‘category’ is hereby understood to denote data according to its semantic meaning, or business function. Said relation or logical association is independent and anytime applicable to whatever type of data in the actual programming sense of, for example, INTEGER, DOUBLE, STRING, etc., e.g., in the C programming language.

Thus, said logical connection between data different in nature and a respective STMS can be used for different purposes, in particular

for increasing the security of data because business-sensible data might consistently and automatically be stored multiple times, or with different physical storage devices, further

for increasing the consistency of data due to a clear separation transparent to the programmer, further

for increasing the efficiency of storage use, because complete storage areas instead of a plurality of separate blocks as in prior art may be (re-)initialized consistently in one step and thus

for increasing the overall reliability of programs in view of avoiding program aborts due to erroneously overwriting storage locations.

Basically, the separation of the STMS can be advantageously provided on a pure logical level by dedicating two distinct physical address spaces for the two STMSs, to work on. Alternatively, an additional physical separation can be undertaken when the particular requirements of the business environment afford it or any other advantage might be drawn therefrom. Thus, e.g., business data which has a generally persistent nature and thus high business relevance is kept safer than in prior art.

From the programmer's point of view when drafting the data definition of any program variables the transient variables are managed by a particular function while the persistent variables, or data, respectively, is managed by a different one. Thus, the separation can be performed by distinct definitions, marks or any other means suited, as it is most appropriate or adequate to the respective programming language. Thus, the inventional concepts can be provided by any compiler extension for the respective programming language.

In particular, if the present invention's methods are applied to embedded systems storage management, like e.g., cashier systems, or car, train, or aircraft electronic systems, etc. three different problems are avoided:

Storage blocks are even deallocated reliably which otherwise are kept stored in a static memory when switching off the system, memory leaks are avoided in the storage area dedicated for storing the transaction data, and a non-desired overwrite of storage areas does not lead to an abort of the program like it does in some prior art systems and rare situations when the control information of a block is erroneously overwritten.

Of course, the approach might be extended to comprise more than two STMSs, and each STMS advantageously may be associated with a particular category of data.

Preferably, a different temporal nature of said program data can be used for distinguishing said data categories. E.g., data, which is used only for a short time interval, may be managed separately and deleted earlier than other more important data of longer temporal relevance. Basically, any desired plurality, of dedicated STMSs may be provided in order to reflect the specific need in a respective business situation in which the application program runs.

According to a further, particular aspect of the present invention said plurality is ‘two’:

The first category data is associated with persistent data, whereas the second category data is associated with transient data, whereby the storage resources used for transient data are re-initialized periodically for each transaction—at the begin or at the end of each transaction. Said re-initialization comprises a deallocation of storage which is not explicitly deallocated by the programmer. Thus, storage efficiency is increased further even if the programmer missed to deallocate some program data, which is really no more needed for the further run of a program.

Said inventive concept can be advantageously applied to programming languages like C, C++, or others which do not provide a so-called ‘garbage collector’ like it is done, for example by the JAVA language.

According to a specific field of use, e.g., when the application program is a cashier program then the term ‘persistent’ program data should be understood as denoting any data which is still further needed for information processing purposes after the end of a transaction performed by the program, whereas ‘transient’ program data may be deleted at the end of a transaction.

In regard of the broad meaning and range of application and the abstract nature of the inventional approach it should be stressed that it comprises other instances of categories as well which have no temporal nature at all. Data may possess a public nature or a private nature, for example. There might be combinations of the two or more categories of data, as well, or subcategories may be set-up whenever the application environment should require that. It is dependent of the specific program logic in question which category instance—transient or persistent—a particular data shall be associated with.

The above-mentioned term ‘transaction’ is to be understood herein to comprise any sequence of program steps which is delimited from the rest of the program by either a semantic separation or a system-specific separation in any program, operating system or middleware or advantageously, application-level program in any business context. For example, a single cashier program transaction comprises a single run of a program loop representing a sequence of program steps, which have to be executed when a number of products are bought by a client. It should be added that the above-mentioned loop run may comprise any number of inner loops, at the end of which the storage resources may rest without initialization in the above sense as long as it seems useful in the context of the present invention's aim to increase the security or reliability of storage management in a program.

Further, if the persistent data is subjected to a checking procedure, as e.g., a check for completeness, consistency, security aspects, etc., then it is advantageous to have filtered out before other data which not worth to be checked. This reduces computing time and memory requirements which is very useful in low-cost devices or pervasive devices as e.g., mobile phones or other hand-held devices as they have only limited resources of memory and computing power.

Apart from the above-mentioned embedded systems the inventive approach can also be advantageously applied in small devices with limited computing and storage resources, in order to avoid storage area to be wasted in the course of a program's run time.

Further, the multiple management of storage can be implemented by functions managed by an operating system in any computer system or computing device—high performance clustered systems until small handheld devices.

### 3. BRIEF DESCRIPTION OF THE DRAWINGS

The present invention is illustrated by way of example and is not limited by the shape of the figures of the accompanying drawings in which:

FIG. 1 is a schematic representation of the basic components when a program is run using the inventional method, and

FIG. 2 is a schematic representation showing the basic structural and functional elements when managing storage resources according to a preferred aspect of the present invention,

FIG. 3 is a schematic representation illustrating the use of memory left part for transient data and right part for persistent data.

### 4. DESCRIPTION OF THE PREFERRED EMBODIMENT

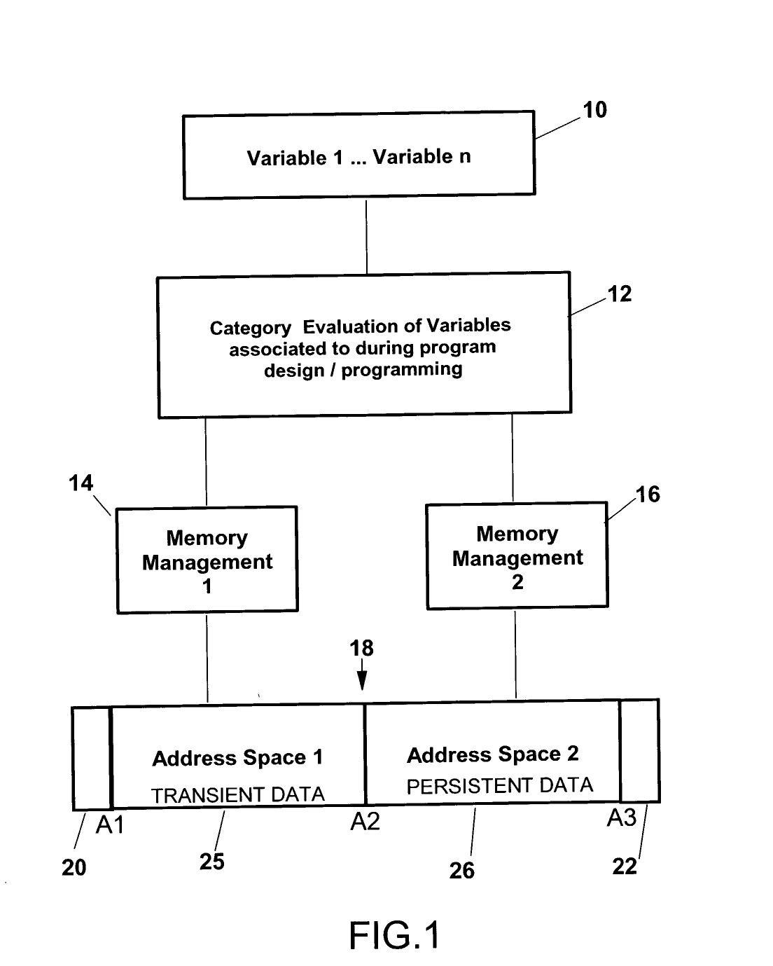

With general reference to the figures and with special reference now to FIG. 1 it is assumed that a cashier program is developed according to an inventional embodiment of the inventional method according to said aspect considering transient and persistent data categories. It is assumed to run the cashier application program at a desk station in a cashier terminal in a shopping market in order to manage the shopping of a plurality of clients.

During the program run a plurality of variables 1, . . . N are used. This is symbolically depicted in box 10. Each variable has an additional characterization, e.g., a flag, which indicates the category, the data has been associated to during the process of program development.

During runtime of said program said flag is evaluated, box 12.

In case of two different flag values present the two different STMSs 14, and 16, respectively, are available for managing respective ones of the above N variables.

In the bottom part of FIG. 1 the address space 18 of the main memory is symbolically depicted. There are provided at least two separate address spaces 1 and 2 covering a range from address A1 to A2, and from A2 to A3, respectively. Embedding address spaces 20, 22 are present as well.

According to said inventional embodiment STMS 1, denoted with reference sign 14 accesses said first address space 25 in order to manage the first category of data, i.e., in here the transient data whereas the second STMS 16 manages the second category data, i.e., the persistent one in a second, separate address space 2 having reference sign 26.

Said accesses include basically any type of storage operation, i.e., read, write, update, delete, etc.

The details according to which the decision transient/persistent is taken in the program and the respective business context are described further below.

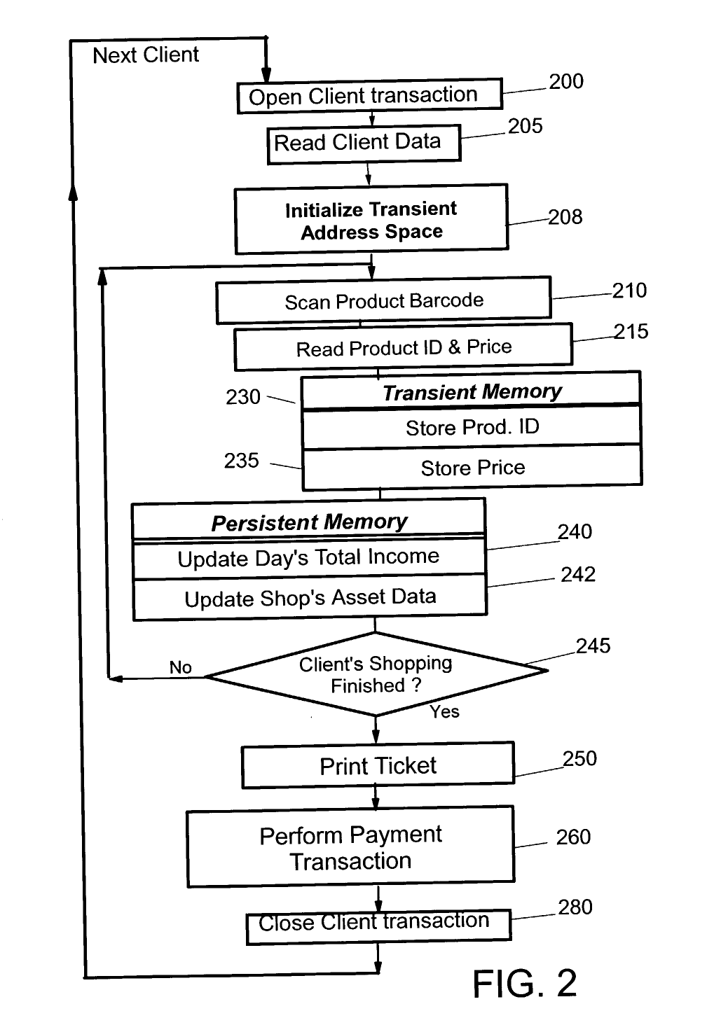

With reference now to FIG. 2 the essential steps of an inventional embodiment are described next below revealing the business context of the data categories ‘transient’ and ‘persistent’, respectively, and an exemplary control flow of the managing method.

First, in a step 200, the client arrives at the cashier terminal and the transaction defining a single client's shopping is opened. The customer data, e.g., the customer ID is read from the client's shopping card, step 205.

Then, the transient address space is initialized, step 208, i.e., all data stored therein belonging to a precedent client's shopping is freed.

Further, in a product-related loop comprising steps 210 to 245 all products are processed the client desires to buy.

Within this loop, in particular the bar code of the product is scanned, step 210, the respective product ID, price and clear name information is read from a products database, step 215. This product information is processed a transient data.

Further, in steps 230 and 235, respectively, the product ID, the number of identical products, the (accumulated) price is stored with STMS 14 in the transient memory in the respective address space 25—see FIG. 1 again.

Then, with the price information just received a persistent program variable decoding “Today's Total Income of the shop” is updated in the persistent memory 25 by adding the price to the precedent value of it, step 240. In a networked environment with a plurality of cashier terminals this can be a Total over a plurality of terminals. Further, the number and the respective product ID are read from the transient memory 26 with STMS 16 in order to update the Asset data of the shop, step 242.

Further, a decision 245 is taken if the client's shopping is finished, i.e., if all products to be purchased have been processed.

In the NO-branch thereof it is branched back to step 210 in order to scan the braced of the next product for analogue processing as described above.

In the YES-branch of decision 245 all products have been successfully processed. Now the receipt ticket is printed out, step 250 and the payment transaction is performed, step 260.

For the purposes of clarity and conciseness of the inventional disclosure which uses prior art methods for performing payment transactions it can be assumed that any payment transaction is successful. Thus, the payment transaction is assumed always successful, and the client gets back his electronic cash card.

Finally, the client transaction is closed, step 280. Then the program is ready to process the next client's shopping. Thus, it is branched back to step 200.

Thus, persistent data like client ID, date of his shopping, the client-related Total To Pay and possibly any other benefit information granted for the client, the Total Income of the shop, and possibly other data not explicitly mentioned in here remains stored in the persistent memory 26.

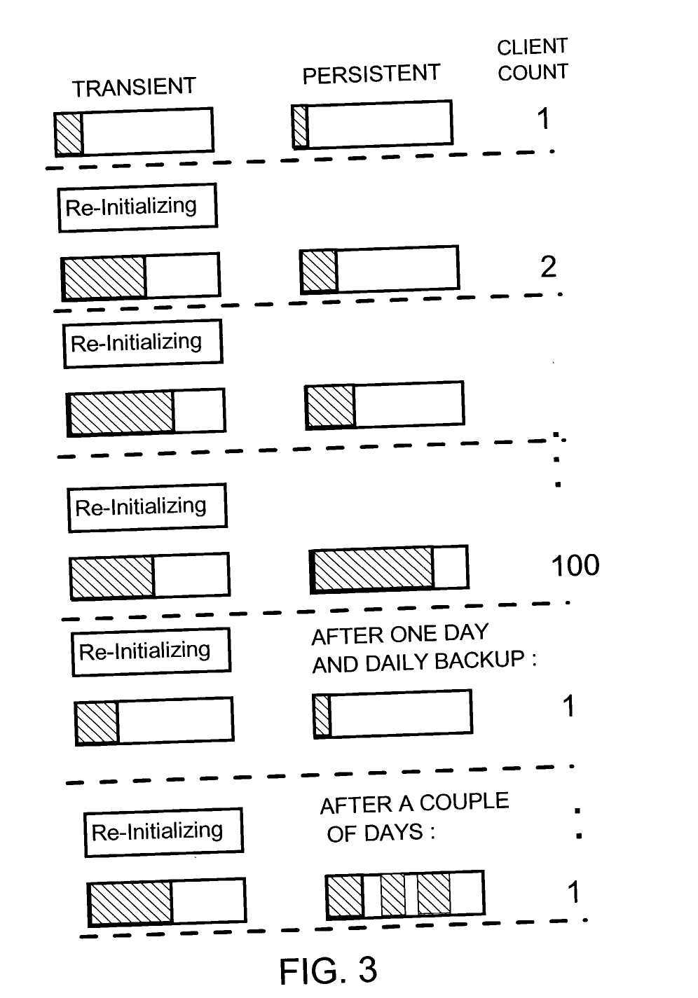

With reference to FIG. 3 the left side illustrates the different use of storage required for storing transient data and for persistent data (right side). Each client's processing is separated from a subsequent one by a broken line, which is indicated by the client loop count, which refers to FIG. 2, steps 200 to 280. The storage space in use is indicated by a respective hatched portion, always at the end of a client's shopping processing, i.e., after the step 280.

Client 100's shopping is assumed to be processed the latest at the given day, depicted in FIG. 3, upper part. It may be appreciated that the persistent data amount (right) thus slowly increases during one day's hours of business as more and more clients make their shopping (time increases downwards) and the above mentioned persistent data is stored for each client's shopping. The next day—after daily backup of persistent data and a partly reset of the persistent data area a small fraction of persistent data is assumed to be remaining at the given storage space, for example, some data statistics and some average value or related data evaluation. Then for example, in case of using a hard disk for storing the persistent data, after some day (see bottom portion, FIG. 3) there might prevail a quite high degree of fragmentation in the persistent data area. Thus, this is the typical situation which is currently found, but which can be handled without a specific risk due to the slow rise and fragmentation of the persistent data storage space.

In the highly frequently used transient data area, however, the above-mentioned risk of fragmentation, etc., is high in prior art. According to the invention, however, always the same easy-to-handle situation is occurred:

In FIG. 3, the transient memory column is depicted at the left side. The large plurality of product-related data, however, i.e., ID-data, price information and clear name information or product class information, or other data if required is ready to be overwritten after the repeated re-initialization step 208 before processing the next client's shopping. This is advantageously done when entering the client-related loop.

According to the invention for each client the transient data STMS sets free the storage space dedicated for temporarily storing the transient data, such that it can be stored into always from the very beginning, for example. The memory is used without any rule as each client has a different shopping. As it can be seen from the figure the storage use is always the same for each client: After flushing, the storage space is filled up with transient data from the very beginning without any gaps, etc. Thus, the storage management is easy and reliable due to repeatedly flushing the transient data storage space.

In a shop offering a plurality of e.g., 10.000 different products the associated cashier program module must allocate and deallocate a lot of storage space during a day's business hours, supposed the cashier system is processed continuously. Then, in prior art cashier systems the above-mentioned problems of memory leaks, wasted, unused, storage, etc., arise.

According to the present invention, however, such problems are reliably solved.

With reference to the implementation of the inventional concept into the source code of an application program a programmer of the application program may use a respective data category bit—or several of them if necessary—in order to mark those transient variables as ‘transient’ with the result that said bit may be evaluated during runtime of the program. Thus, transparent data is processed by said separate STMS provided for transient variables. Thus, the compiled, executable program can automatically invoke the separate STMS according to the provisions done in the source code.

Further, and with reference to the general nature of the present invention, for example the Card ID of the client is a data having an enormous business importance for the shop as it represents base information for being paid by the client's bank. Thus, in order to respect said business importance the program variable that stores the client's card ID and the variable ‘TotalToPay’ is considered as persistent and additionally as ‘important’. Thus, being qualified as ‘important’ the variable contents are processed specifically—e.g., they are saved separately on a distinct data carrier extern from the cashier terminal and extern from the shop itself, for example, thus taking into account the increased security requirements for such business data.

Thus, the shop's electronic cashier system benefits twice from the logical association provided by the present invention, between the nature of a program variable and a respective automated adequate processing of said variables: First, the security against data loss is increased automatically, as the card-IDs are saved separately and thus redundantly, and second, the above-mentioned memory leaks are avoided, as the whole storage area provided for transient data is re-initialized at the begin of each loop, i.e., transaction.

Further, it should be added that the above selection of categories is a specific one having the above described purpose and advantages. Other selections surely exist which are different as they might focus a different aspect in the application environment. Thus, for example, a transaction might be defined differently and thus comprising the program steps required to determine the money which has come in at a whole day, month, or whatever time, either at a single cashier station, a plurality of them, or accumulated in whatever combination over any number of inter-correlated shops.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

The present invention can be advantageously applied to programs running in embedded systems, in particular in those which have limited storage resources because in that systems the runtime stability is remarkably increased when there is an inventional ‘guaranty’ to reset the respective complete transient data category storage area whenever a respective transaction, loop, etc., has completed. The guaranty is implied by the fact that a contiguous address space is consistently reset instead of deallocating a plurality of blocks representing each one or a plurality of variables and covering usually a non-contiguous address space.

The present invention can be realized in hardware, software, or a combination of hardware and software. A storage resources management tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general-purpose computer system with a computer program that, when being loaded and executed, controls the computer system such that it carries out the methods described herein.

The present invention can also be embedded in a developer's workbench, or into any compiler tool for any programming language without any prior art garbage collector means i.e., a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following

a) conversion to another language, code or notation;

b) reproduction in a different material form.

1. A method for managing storage resources (25,26) while running a program application, characterized by the steps of:
managing (230, 235) program data of a first category with a first Storage Management System (STMS) (14), and
managing (240, 242) program data of a second category with a second STMS (16), and
the different management of said data categories being driven by application-specific requirements.

2. The method according to claim 1 in which a different temporal nature of said program data is used for distinguishing between said data categories.

3. The method according to claim 1 in which said first-type program data is persistent data, and said second-type data is transient data,
further comprising the step of:
re-initializing (208) the storage resources (25) used for transient data for each transaction (208, . . . 280).

4. The method according to claim 1, 2 or 3 used for embedded systems.

5. A computer system having installed program means for performing the steps of a method according to one of the preceding claims.

6. The computer system according to the preceding claim being an embedded system.

7. A computer program for execution in a data processing system comprising computer program code portions for performing respective steps of the method according to anyone of the claims 1 to 4 when said program is loaded into said data processing system.

8. A computer program product stored on a computer usable medium comprising computer readable program means for causing a computer to perform the method according to anyone of the claims 1 to 4 when said computer program product is executed on a computer.
